(19) United States
(12) Patent Application Publication
(10) Pub. No.: US 2015/0141098 A1
(43) Pub. Date: May 21, 2015

(54) INCLINED CONVEYOR FOR COMBINE HARVESTERS

(71) Applicant: Arnold Jäger Holding GmbH, Hannover (DE)

(72) Inventors: Jan-Harm MULDER, Dalen (NL); Johan OORD, Groningen (NL); Sebastian JÄGER, Hannover (DE)

(21) Appl. No.: 14/548,813

(22) Filed: Nov. 20, 2014

Related U.S. Application Data
(63) Continuation of application No. PCT/DE2013/100180, filed on May 16, 2013.

(30) Foreign Application Priority Data
May 21, 2012 (DE) 10 2012 010 280.1

(51) Int. Cl. A01D 61/00; A01F 12/10

(52) U.S. Cl. CPC A01D 61/008; A01F 12/10
USPC 460/114

(57) ABSTRACT

An inclined conveyor for a combine harvester has at least two endless traction elements (drive elements) which extend in parallel to one another and which are interconnected by carrier bars. The carrier bars are situated transversely with respect to the conveying direction. The inclined conveyor is configured so that the load on the drive element is reduced due to the low weight of the carrier bars and a lower conveying speed. The carrier bars on the conveyor have at least two rods situated one on top of the other, have a circular cross section, and are fastened to the drive element as individual rods.

### RELATED APPLICATIONS

This is a continuation of International PCT Application No. PCT/DE2013/100180, filed on May 16, 2013, which claims priority from Germany Application No. 10 2012 010 280.1, filed May 21, 2012, both of which are hereby incorporated by reference.

### FIELD OF THE INVENTION

The present invention relates to an inclined conveyor for a combine harvester according to the preamble of claim 1.

### BACKGROUND OF THE INVENTION

Combine harvesters are equipped with an attachment which has a reel for collecting the harvested crop, and a cross auger, situated downstream from the reel, which compacts the harvested crop and conveys it toward the center to an inclined conveyor. The inclined conveyor is situated in a duct, and conveys the harvested crop into a threshing device of the combine harvester.

Inclined conveyors of this type for combine harvesters are well known in the prior art, for example from DE 1199039, U.S. Pat. No. 3,555,790, DE 4132246 A1, DE 4311054 C2, DE 102009036104 B4, EP 1733607 B1, and DE 102005027841 A1. These inclined conveyors have at least two endless traction means which extend in parallel to one another and which are interconnected by carrier bars situated transversely with respect to the conveying direction. The carrier bars feed the harvested crop into an undershot conveyor duct of a threshing unit of the combine harvester. The carrier bars are connected to the traction means by screws.

DE 861 071 describes a rod conveyor whose traction members are designed as unarticulated flexible bands, for example as rubber bands with fabric plies. Holding sleeves which are insertable into the ends of round rods are situated on these bands.

A rod conveyor for compacting harvested crops is known from DE 10 2004 023 705 B3. This conveyor has crossbars with a circular cross section, which have a bend at their end-side areas of connection to the traction means.

Standard steel profiles such as U, L, and T profiles which are not heat-treated are used as carrier bars according to the prior art. These carrier bars have a low profile height and a limited conveying action due to their low form resistance to the harvested crop. In addition, the profiles are very smooth, and therefore have a very low degree of frictional engagement with the harvested crop. Due to the friction of the harvested crop at the bottom of the conveyor duct and the moderate entrainment effect of the carrier bars, during operation there is a considerable difference in speed between the carrier bars and the harvested crop stream (slip). This results in a high level of energy consumption, a high degree of wear, a high load on the conveyor chain, and a premature threshing effect.

The carrier bars are subject to very high loads during operation. Thus, high tensile stresses occur on the carrier bars due to the centrifugal forces which act on the deflection points of the traction means. In addition, this results in compressive stress in the carrier bars during the subsequent contact with the harvested crop stream. Furthermore, there are tensions due to torsion of the carrier bars during nonuniform flow of the harvested crop over the length and width of the conveyor duct. There is also bending due to the entrainment of the harvested crop in the plane of the crops. In addition, large loads occur on the carrier bars when large or heavy foreign objects enter into the harvested crop stream.

Large planar moments of inertia and moments of resistance are necessary to be able to withstand these loads. For this reason, the carrier bars are very heavy. The high weight limits the conveying speed due to the very high centrifugal forces in the deflections. In addition, the system has a tendency to oscillate, causing the carrier bars to strike the walls of the conveyor duct and produce high noise levels.

### SUMMARY OF THE INVENTION

An object of the present invention is to provide an inclined conveyor of this generic type for a combine harvester, in which the load on the traction means is reduced due to a low weight of the carrier bars and a lower conveying speed.

This object is achieved according to the invention by an inclined conveyor having the features of claim 1.

In a complete departure from the prior art which, as described above, provides for the use of heavy standard steel profiles as carrier bars, the carrier bars according to the present invention are made up of at least two rods, situated one on top of the other, which have a circular cross section and which are fastened to the traction means as individual rods. Due to the circular cross section of the rods, the bending and torsion loads acting on the rods during operation of the inclined conveyor cause only low peak stresses. The rods may therefore be designed with a small diameter, and are thus very flexible. As a result, the yield point of the rod material is not reached, even under unfavorable load situations (glass fiber principle). Although the rods have a small diameter, due to the superposed arrangement of at least two rods the rods protrude farther into the conveyed material stream than the heavy standard steel profiles used according to the prior art. For this reason alone, the entrainment effect of the carrier bars on the harvested crop is increased.

In one advantageous embodiment, the entrainment effect may be increased even further by providing the rods with a friction enhancing casing.

Further advantageous embodiments of the invention result from the dependent claims.

### BRIEF DESCRIPTION OF THE DRAWINGS

The invention is explained in greater detail below with reference to the embodiments. In the accompanying drawings;

FIG. 1 shows a schematic side view of a combine harvester having a cutter unit and an inclined conveyor;

FIG. 2 shows a perspective view of a connecting point between a carrier bar and a traction means of the inclined conveyor;

FIG. 3 shows a perspective view of a carrier bar of the inclined conveyor according to a second embodiment of the invention; and

FIG. 4 shows a cross section of a carrier bar according to a third embodiment of the invention.

### DETAILED DESCRIPTION OF THE INVENTION

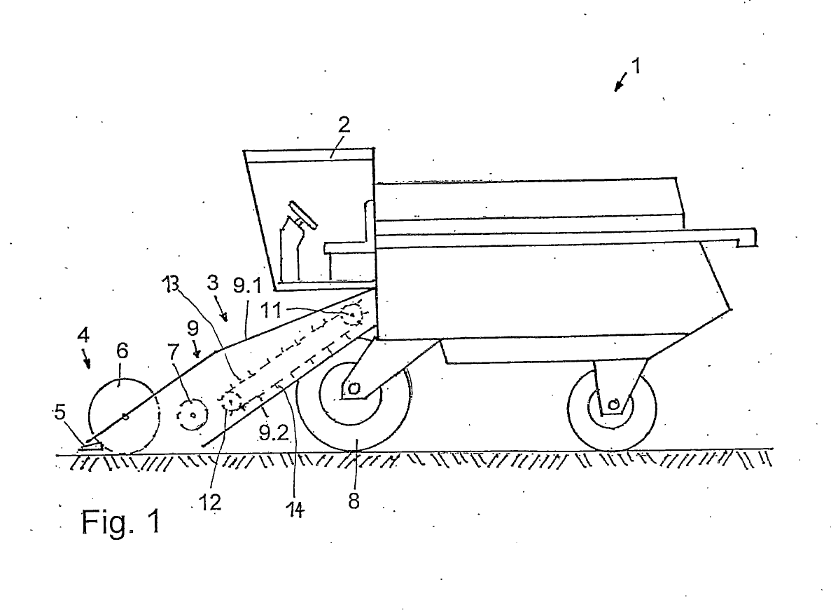

FIG. 1 shows a self-propelled combine harvester 1. Beneath the driver's cab 2, an inclined conveyor 3 extends downwardly toward the front. On its front end the inclined conveyor bears a cutter unit 4 made up of a cutter bar 5, a reel 6, and a cross auger 7. The cutter unit 4 is significantly wider than the combine harvester 1, and customarily extends transversely beyond the front drive wheels 8 of the combine harvester, while the inclined conveyor 3 is narrower. The harvested crop is cut by the cutter bar 5, collected by the reel 6, and supplied to the cross auger 7. The cross auger 7 compacts the harvested crop and conveys it toward the center, and supplies it to the inclined conveyor 3. The inclined conveyor is situated in a conveyor duct 9 having a top wall 9.1, a bottom wall 9.2, and two side walls. The inclined conveyor 3 feeds the harvested crop on the bottom wall 9.2 of the conveyor duct 9 to a threshing unit (not illustrated) of the combine harvester 1.

The inclined conveyor 3 has a conveying direction and includes at least two endless traction means or traction elements or drive elements 13 which extend in parallel to one another and which are interconnected by carrier bars 14 situated transversely with respect to the conveying direction. The drive elements 13 revolve around an upper traction means guide 11 and a lower traction means guide 12 in the conveyor duct 9, the upper traction means guide 11 being driven, and the lower traction means guide 12 co-rotating.

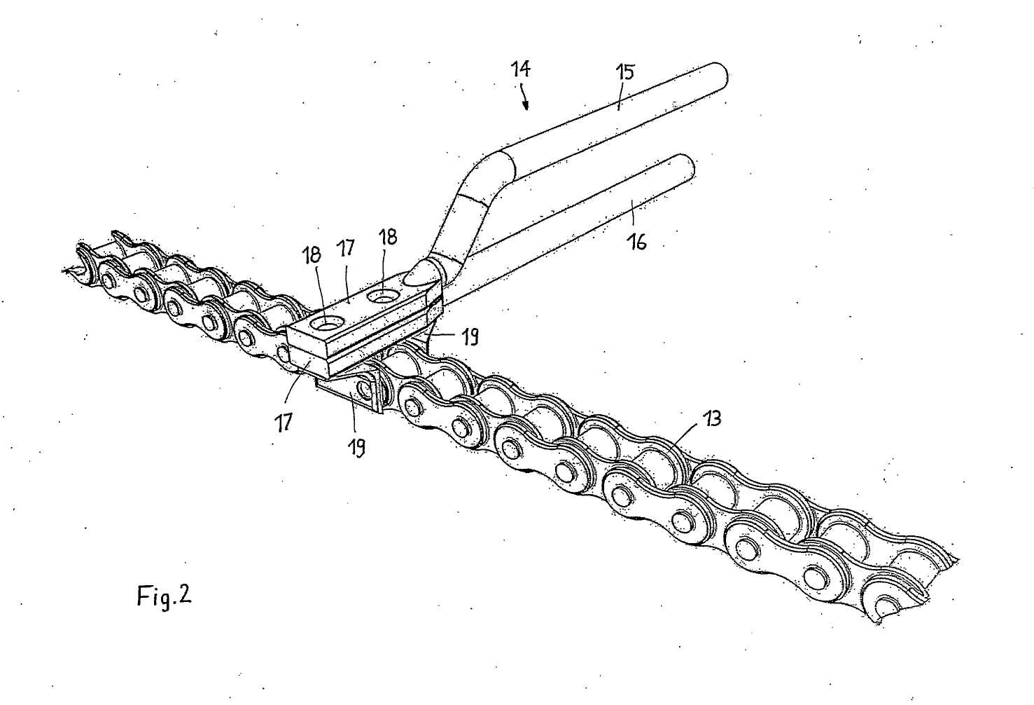

The traction means 13 is a roller chain in the exemplary embodiment shown in FIG. 2. A cam belt made of a polymer reinforced with high tensile strength plies may also be used as the traction means 13. This has the advantage that elongation of the traction means 13 due to wear, and thus, abrasion of the carrier bars 14 against the duct walls, is avoided.

As mentioned above, the at least two traction means 13 extending in parallel to one another are joined together at regular intervals by carrier bars 14. Only one side of the inclined conveyor 3 is illustrated in FIG. 2. The other side has a mirror-image design, so that the following statements also apply to this side.

In the embodiment according to FIG. 2, the carrier bars 14 are made up of two rods 15, 16 having a circular cross section. At their ends, each of the rods 15, 16 is provided with a flattened area 17 which is used to fasten the rods 15, 16 to the traction means 13. For this purpose, the flattened areas 17 are provided with two through holes 18 separated at a distance from one another. For fastening the rods 15, 16 to the traction means 13, the flattened areas 17 are placed one on top of the other so that their through holes 18 are mutually aligned. At the fastening points, the flattened areas 17 rest on flange plates 19 which are attached to the traction means 13, and which in each case are provided with a through hole, not visible in the drawing, the distance between these through holes corresponding to the distance between the through holes 18 in the flattened areas 17. For fastening the rods 15, 16 to the traction means 13, rivets (not illustrated in the drawing) are inserted through the aligned through holes 18 in the flattened areas 17 and the flange plates 19, and riveted. Of course, a screw connection may also be used instead of a rivet connection.

In the example shown in FIG. 2, the rods 15, 16 have a shared fastening point to the traction means 13. Alternatively, the rods may have fastening points to the traction means 13 which are situated next to one another, which is not illustrated in the drawings.

In the embodiment according to FIG. 2, the rod 16 is straight, while the rod 15 of the carrier bar 14 in the harvested crop stream is bent.

To make the carrier bars 14 even lighter, the rods 15, 16 may also be designed as hollow rods.

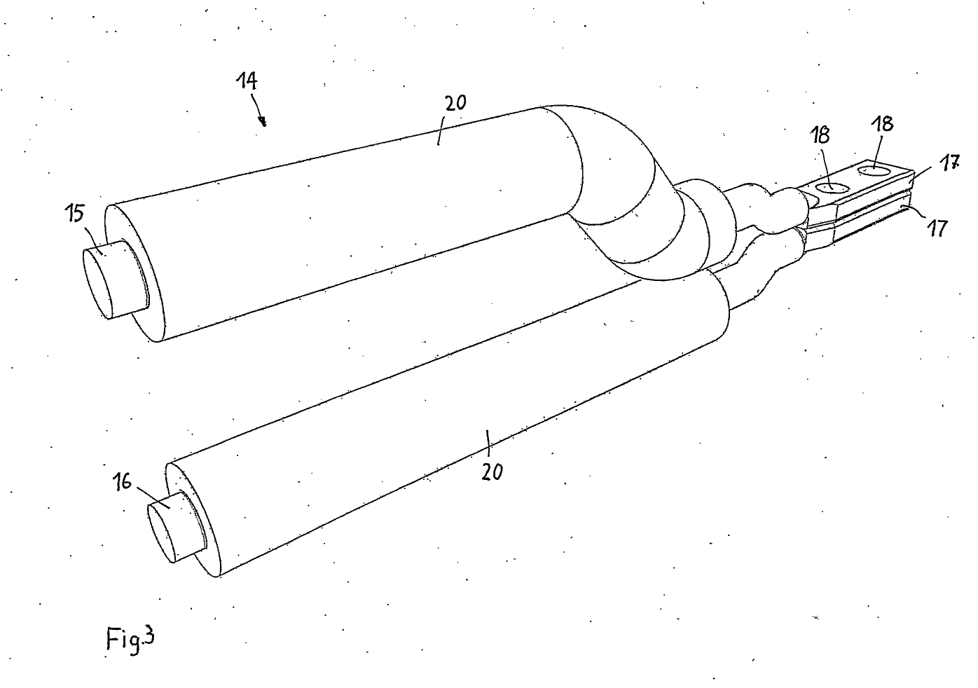

FIG. 3 illustrates another embodiment of a carrier bar 14. This embodiment differs from the embodiment according to FIG. 2 solely in that the rods 15, 16 are each provided with a concentrically arranged casing 20 made of a material with a high coefficient of friction, such as rubber. This casing 20 improves the frictional engagement of the carrier bars 14 with the harvested crop, and thus increases the entrainment effect.

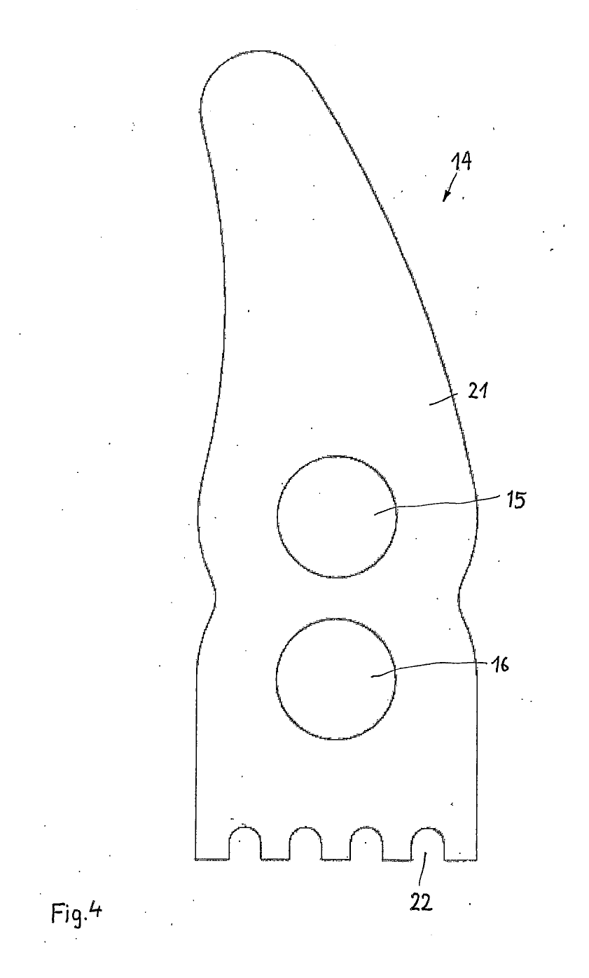

FIG. 4 shows a cross section of a carrier bar 14 in which the rods 15, 16 have a shared casing 21 having the shape of a wing that is approximately perpendicular to the plane of the conveyor. The casing 21 is likewise made of a material which increases friction, such as rubber. To further increase the entrainment effect of these carrier bars 14, their end face which faces the bottom wall 9.2 of the conveyor duct 9 is provided with longitudinal grooves 22.

In the exemplary embodiments described above, the rods 15, 16 are produced from a cold-drawn spring steel wire or hot-rolled, tempered wire having a yield point of greater than 1000 N/mm². The rods 15, 16 have a length of approximately 500 mm and a diameter of approximately 15 mm. The rods 15, 16 may also be made completely or partially of a fiber composite.

1-10. (canceled)

11. An inclined conveyor for a combine harvester, the inclined conveyor having a conveying direction, and comprising:
a) two endless drive elements which extend in parallel to one another, and are interconnected by carrier bars situated transversely with respect to the conveying direction of the two endless drive elements; and
b) the carrier bars having at least two rods situated one on top of the other, each having a circular cross section, and each being fastened to the two drive elements as individual rods.

12. The inclined conveyor according to claim 1, wherein:
a) the two rods of a carrier bar have a shared fastening point on drive element.

13. The inclined conveyor according to claim 11, wherein:
a) the two rods of a carrier bar have fastening points on the drive element which are situated next to one another.

14. The inclined conveyor according to claim 11, wherein:
a) the two rods are provided with a friction increasing casing.

15. The inclined conveyor according to claim 14, wherein:
a) the friction increasing casing is arranged concentrically with respect to each of the two rods.

16. The inclined conveyor according to claim 14, wherein:
a) the two rods have a shared casing, the casing being in the form of a wing that is substantially perpendicular to a plane of the inclined conveyor.

17. The inclined conveyor according to claim 11, wherein:
a) the two rods are produced from cold-drawn wire or hot-rolled, tempered wire.

18. The inclined conveyor according to claim 11, wherein:
a) the two rods are hollow.

19. The inclined conveyor according to claim 11, wherein:
a) the two rods are made at least partially of a fiber composite.

20. The inclined conveyor according to claim 11, wherein:
a) the drive element is a belt made of a polymer reinforced with high tensile strength plies.
